(19) United States
(12) Patent Application Publication
(10) Pub. No.: US 2020/0213332 A1
(43) Pub. Date: Jul. 2, 2020

(54) Real-Time Email Address Verification

(71) Applicant: VIRUTHAGIRI THIRUMAVALAVAN, ARIYALUR (IN)

(72) Inventor: VIRUTHAGIRI THIRUMAVALAVAN, ARIYALUR (IN)

(21) Appl. No.: 16/788,496

(22) Filed: Feb. 12, 2020

Related U.S. Application Data
(63) Continuation-in-part of application No. 16/544,941, filed on Aug. 20, 2019.
Application No. 16/544,941 is a continuation-in-part of application No. PCT/IB2019/056979, filed on Aug. 19, 2019.
(60) Provisional application No. 62/805,862, filed on Feb. 14, 2019.
(60) Provisional application No. 62/720,681, filed on Aug. 21, 2018.
(60) Provisional application No. 62/805,862, filed on Feb. 14, 2019.
(60) Provisional application No. 62/720,681, filed on Aug. 21, 2018.

(51) Int. Cl. H04L 29/06; H04L 12/58

(52) U.S. Cl. CPC H04L 63/126; H04L 51/28; H04L 63/0892

(57) ABSTRACT

System and methods are provided to verify an end user email address in real time during registration without sending a real electronic message. The end user creates a domain-based email address for a service beforehand, which is tied to a domain name. When the user submits the registration form, the server receives a real-time verification request from the service. The server validates the request. When the validation passed AND the domain-based email address was created during the last 24 hours, the server responds with creation IP address and the creation time. The client checks whether the IP address matches the signup address and compares the signup time with email address creation time. The end user is finally marked as verified. If there are any discrepancies, then the client sends a normal “confirm your email address” mail.

### CROSS-REFERENCE TO RELATED APPLICATIONS

This application is a continuation-in-part of pending U.S. patent application Ser. No. 16/544,941, titled “Domain-based Isolated Mailboxes” filed on Aug. 20, 2019, which claims priority to U.S. Provisional Patent Application Ser. No. 62/805,862, titled “Domain-based Isolated Mailbox” filed on Feb. 14, 2019, now active and to U.S. Provisional Patent Application Ser. No. 62/720,681, titled “Domain-based Isolated Mailbox” filed on Aug. 21, 2018, now expired. Additionally, this application is a continuation-in-part of PCT Patent Application Serial No. PCT/IB2019/056979, titled “Domain-based Isolated Mailboxes” filed on Aug. 19, 2019, which claims priority to U.S. Provisional Patent Application Ser. No. 62/805,862, titled “Domain-based Isolated Mailbox” filed on Feb. 14, 2019, now active and to U.S. Provisional Patent Application Ser. No. 62/720,681, titled “Domain-based Isolated Mailbox” filed on Aug. 21, 2018, now expired. The complete disclosures of the above patent applications are hereby incorporated by reference in their entireties for all purposes.

### TECHNICAL FIELD

The present invention relates generally to electronic mail. More particularly, relates to systems and methods for verifying an email address without sending any real email message to the end user.

### BACKGROUND

Today consumers need to go back and forth to confirm their email address. Email address verification is necessary in order to comply with country-specific spam laws. E.g. CAN-SPAM Act.

If a business does not verify the submitted email address, then they may be spamming innocent people who never submitted their email address.

For example, an abuser submits jeff@amazon.com address in your email newsletter subscription form. If you keep sending your newsletters without verifying email address, then you are sending spam to Jeff Bezos.

Some study says around 25% of the users never confirm their emails. So from the business perspective, they lose 25% of the potential customers.

This specification offers a way to simplify that process. Email addresses are verified in real-time. In other words, users don't have to leave the website/app to verify their email address.

### BRIEF DESCRIPTION OF THE DRAWINGS

FIG. 1A illustrates a simple SMTP conversation between two mail servers.

FIG. 1B is a table that shows where domains are extracted from.

FIG. 2A illustrates the box groups.

FIG. 2B illustrates the box types.

FIG. 3A illustrates subdomain-based Dombox email address structure.

FIG. 3B illustrates dollar-based Dombox email address structure.

FIG. 3C illustrates Custom-TLD based Dombox email address structure.

FIG. 4A illustrates the Dombox mail system architecture.

FIG. 4B illustrates the mandatory pass layers for each box type.

FIG. 4C illustrates the incoming mail check layers.

FIG. 5A illustrates mail session structure.

FIG. 6 illustrates the logical flow of SAD.

FIG. 7 illustrates the logical flow of SAD record selection.

FIG. 8A illustrates SAD Direct Pass.

FIG. 8B illustrates SAD Indirect Pass.

FIG. 9A illustrates the SAD layer validation process.

FIG. 10A illustrates the “set domkey” page layout.

FIG. 10B illustrates the “Add Dombox” page layout.

FIG. 100 illustrates the “All Domboxes” page layout.

FIG. 11A illustrates a “third party registration page” where Dombox email address can be used.

FIG. 11B illustrates generic “Mails” page layout.

FIG. 11C illustrates the normal verification mail.

FIG. 11D illustrates the “View Dombox” page layout.

FIG. 11E illustrates icon-click “dombox address generation” via browser extension.

FIG. 11F illustrates right-click “dombox address generation” via browser extension.

FIG. 11G illustrates pop-up “dombox address generation” via browser extension.

FIG. 12 illustrates a sample real-time verification request.

### DETAILED DESCRIPTION

Various aspects of the invention will be described with reference to details discussed below, and the accompanying drawings will illustrate the various aspects. The following description and drawings are illustrative of the invention and are not to be construed as limiting the invention. Numerous specific details are described to provide a thorough understanding of various aspects of the present invention. However, in certain instances, well-known or conventional details are not described in order to provide a concise discussion of the present invention.

This specification deals with SMTP. But the invention can also be implemented on other protocols like HTTP(S).

### 1. Email Overview

### 1.1. Mail Classifications

Mails are classified into three major categories. Conversational Mails, Transactional Mails and Promotional Mails

### 1.1.1. Conversational Mails

Conversational mails are all about you versus another human. If the person who is sending you mail is a human, then such mails go under conversational mails. You can add reply to these mails and will be read by a human on the other end. Small businesses sometimes depend on third-party mail hosting services for hosting their conversational mails for security reasons. e.g. Gmail for Business, Zoho Mail etc.

### 1.1.2. Transactional Mails

Transactional emails are all about you versus the website/app server. These mails are automatically triggered when you interact with the website/app. Think of it as a transaction between you and the website/app. The transaction can be money or data. You need to be notified for the transaction. Transactional emails are usually sent out from the original website servers. i.e. Without depending on any third-party services. However, there are third-party transactional email API services available too. e.g. AmazonSES, Mailgun, Postmark etc. If you are the only recipient of a mail sent by a website, then most likely it's a transactional mail. The following are some of the examples for Transactional Mail. Mails triggered when you sign up to a website. Mails triggered when you reset passwords. Mails triggered when you place an order. Mails triggered when you update your profile on a website. Mails triggered during certain website events. (Monthly Invoices, New friend request, New Facebook Likes, New Twitter Follower etc.). Confirmation Emails, Welcome Emails, Product Shipping Notices. Purchase Receipts etc.

### 1.1.3. Promotional Mails

Promotional mails are very different from transactional emails. When it comes to promotional mails, you are not the only recipient. So promotional mails are all about website marketing team versus their users. Since you are one of their users, that includes you too. Marketing team drafts the mail and then send it to all users in bulk. Promotional mails usually contain tracking links. Small businesses usually depend on third-party newsletter services like mailchimp to send out promotional emails. This is because third-party services offer better tracking tools. e.g. how many people opened your emails, how many people clicked the links, how many people unsubscribed etc. As per law, promotional emails require unsubscribe links. Transactional emails are not.

Notes: Both Transactional Mails and Promotional Mails are related to websites. So let's group them as “website related mails”. Keep in mind, You don't need a website to send Transactional Mails and Promotional Mails. e.g. A mobile app can send Transactional Mails with the help of third-party transactional mail services (e.g. AmazonSES) and they can send Promotional Mails via third-party newsletter services (e.g. MailChimp). For better understanding, we use the term “website related mails” to refer both Transactional Mails and Promotional Mails. This content on this patent specification mainly focuses on web platform to explain the concepts better. It should be noted, the current invention can also be used without utilising the web platform. For example, Google Play store contains more than 2 million Android apps. They can implement our system without utilising the web platform.

The term “Service” generally refers to an application that collects email addresses from users and communicate with the users by sending one or more emails to the collected email addresses. e.g. web app, mobile app, desktop app, apps on gaming consoles, apps on smart watches, apps on smart televisions etc. The service may use APIs to collect email addresses. E.g. OAuth apps

The term “Service Mails” generally refers to one or more mail sent by the “Service”. More often than not “Service Mails” falls under the Transactional Mails and Promotional Mails category. Both “Service Mails” and “website related mails” refers to the same mails. From the term perspective, “Service Mails” is a broader term for “website related mails” since the word “website” seems like it focuses only on the websites.

The term “Service Owner”, “Business Owner” and “Service Administrator” generally refers to the person who has the management privileges for the service. E.g. Editing DNS records, Perform domain verification, Register client applications etc.

The term “Service Provider” generally refers to an entity that provides one or more services. The entity can be a company or a natural person. For example, Facebook, Inc. is the “Service Provider” of “Facebook”, “Instagram”, “WhatsApp” etc. An individual can be an app developer of one or more mobile apps.

The term “Service Domain” generally refers to the “Primary Domain” associated with the service. E.g. Instagram may have the domain “instagram.com” for the web app. Angry Birds mobile app may be associated with “angrybirds.com”. In some cases, a service may not have any “Service Domain”. E.g. A sudoku mobile app created by a student.

The term “Service Provider Domain” refers to the “Primary Domain” associated with the service provider. E.g. Facebook may have the domain “facebook.com”. In some cases, “Service Domain” and “Service Provider Domain” will be the same. E.g. Quora.com, Stripe.com etc.

The term “Platform” refers to the software environment where one or more services can be installed or hosted. Websites are hosted on web platform. Mobile apps are installed on Android, iOS platforms. Desktop applications can be installed in Windows platform, MacOS platform etc.

The term “Service ID” and “Service Identifier” generally refers to the unique identifier that identifies the app in that particular platform. For example, web apps are identified via domain names. So “acme.com” is an example “Service ID” for a web app. Mobile and Desktop apps can be identified via “App ID”.

The term “Transactional mail Service” refers to the third-party application that lets the service to send Transactional emails. E.g. AmazonSES, Mandrill, Mailgun etc.

The term “Promotional mail Service” refers to the third-party application that lets the service to send Promotional emails. E.g. Mailchimp, AWeber etc. These third-party applications also referred as “Third-party newsletter service”, “Email marketing newsletter service” etc.

The term “User” and “Consumer” generally refers to the person who use our mail system.

The term “Business” generally refers to the “Service”. Businesses usually owns at least one domain. Businesses usually send mails from those owned domains to the user rather than using free mail addresses like Gmail.

The term “Identity provider” refers to the system that create, maintain and manage identity information of users and provide the data of such users to other service (e.g., websites, mobile apps, desktop apps etc.). “Sign in with Facebook” and “Sign in with Google” are the two most popular identity providers on the present internet.

The term “box” refers to any mailbox that has the capability of receiving emails.

An email can originate from any external source. Service and Service Providers would like to whitelist only a certain computers on the network to send mails. These computers can be identified using Email address, domain or IP address. Email Address, Domain or IP address can also be provided as hashes.

The term “Source Identifier” refers to any of the following.

(1) domain e.g. acme.com, test.example.com etc.
(2) IP address. E.g. 172.16.254.1, 2001:db8:0:1234:0:567:8:1 etc.
(3) Email Address e.g. johndoe@gmail.com
(4) domain hash e.g. 1f7a882ba1548f4541515fddd70d8f58
(5) IP address hash. E.g. d77c51bbe41116c5d4fe2f75347bee8a
(6) Email Address Hash. e.g. 29a1df4646cb3417c19994a59a3e022a

### 1.2. Email Parts

An email can be divided into two parts. (i) Envelope Part—This part is intended for mail handling servers. (ii) Message Part—This is the part that gets displayed to the user.

### 1.3. Sample SMTP Chat

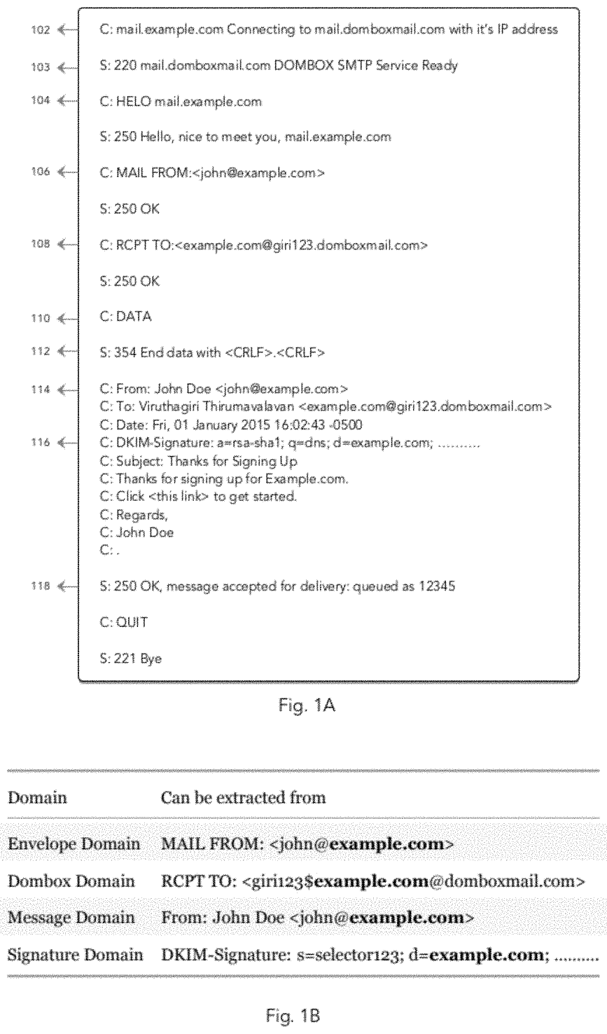

FIG. 1A illustrates a simple SMTP conversation between two mail servers. The content found between the code “354” 112 and “250” 118 is called “Message Part”

### 1.4. The Four Domains

Our system deals with the following 4 domains. Envelope Domain, Dombox Domain, Signature Domain, Message Domain. FIG. 1B is a table that shows where those 4 domains are extracted from.

Note: In certain circumstances, Envelope Domain can be empty. In such cases, we fallback to HELO/EHLO Domain.

### 1.5. The Three Domains

“Dombox Domain” is something we are introducing and it's applicable only to our system. All other email systems on the internet deal with only the other three domains. i.e. Envelope Domain, Message Domain and Signature Domain. Just for the sake of this specification, let's classify the mails into three types. Excellent Mails, Normal Mails, Abnormal Mails. We can call a mail as “excellent” when all three domains are the same. We can call a mail as “normal” if only the “Envelope Domain” is different. The “Envelope Domain” can be different when third party services used for sending emails. So we consider such emails as Normal. e.g. Mailchimp, Sendgrid, AmazonSES. We can call a mail as “abnormal” when the “Signature Domain” doesn't match the “Message Domain”. The whole purpose of the signature is to make sure the message has not been modified in transit. Thus it should be signed by the “Message Author”. i.e. Where it originates=>The “Message From” domain. When the “Signature Domain” doesn't match the “Message Domain”, Gmail adds a “via” text when displaying “Message From” header. So the end user can understand that the message has not been modified in transit, but someone else signed the message.

### 2. Box Groups

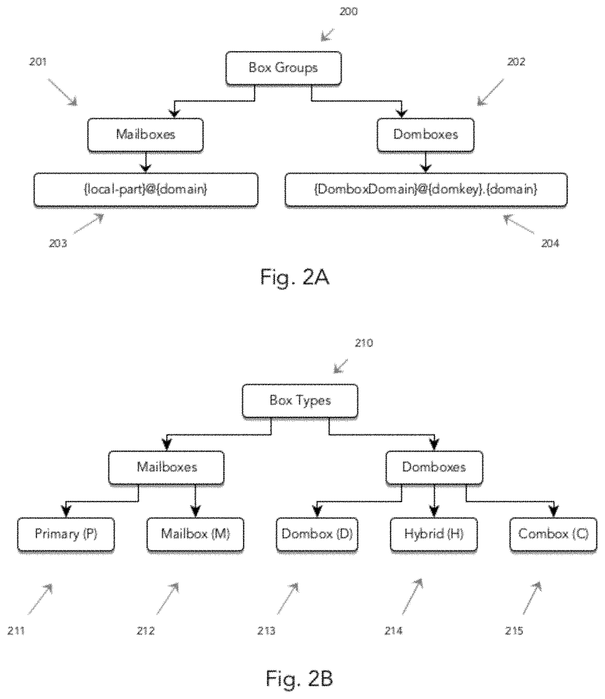

FIG. 2A illustrates the box groups. The boxes are divided into two groups. Mailboxes 201 and Domboxes 202. Mailboxes 201 refers to “Normal Mailboxes”. Domboxes 202 refers to “Isolated Mailboxes”.

2.1. Normal Mailboxes Aka. Mailboxes

These boxes works exactly like the mailbox found in other mail services. e.g. Gmail. When a user signup to our mail service, the user will get one normal mailbox for free. This “one normal mailbox” is called “Primary (P)” Mailbox in our system. A “box” found in Mailboxes 201 group is called “Mailbox”. The term “Mailbox” generally refers to any box found in “Mailboxes” group unless or otherwise specified. The boxes found in this group can accept mails from anyone including spammers. In our system “Normal Mailboxes” should be used only for “Conversational Mails”. Address structure: local-part@domain 203. e.g. johndoe@domboxmail.com. The addresses found in this category are called “email address” or “e-mail address”. These addresses are also known as “Mailbox Address”. Since these addresses should be used only for “conversational mails”, these addresses can also be termed as “Conversational Email Address” or simply “Conversational Address”.

2.2. Isolated Mailboxes Aka. Domboxes

A “box” found in Domboxes group 202 is called “Dombox”. The term “Dombox” always refers to any box in “Domboxes” group unless or otherwise specified. Dombox is the short form for “Domain-based Isolated Mailbox”. Users are gonna create a separate mailbox for each domain. Each of this separated (i.e. Isolated) mailbox is called Dombox. Normal Mailboxes are nothing but “Shared” Mailboxes. Domboxes are “Dedicated” Mailboxes. The boxes found in this group can accept mail only from the “Dombox Domain” and its “SAD domains”. The term “Dombox Domain” and “SAD Domains” will be explained in a later section. Isolated Mailboxes should be used only for Transactional and Promotional Mails. The addresses found in this category are called “imail address” or “i-mail address” which stands for “isolated mail address”. These addresses are also known as “Dombox Address”. A user can have unlimited Domboxes. All emails you receive from websites usually fall under either Transactional or Promotional Mails category. The internet has 332 million domains as of 2018. But the user is gonna create Domboxes only for the site he/she about to sign up. If the user signup to 1 website every week, that will be around 52 websites every year. Domboxes doesn't have to be created manually. A Dombox can be created in many ways. Manually, Via Teleport button, Via Telescribe button, Via native browser support like “Manage Dombox Addresses” (e.g. Google Password Manager on Chrome where you see “Manage Passwords” option), Via browser extensions, Via mobile or desktop clients etc. Dombox email address structure splits the “local-part” into two parts via Dollar symbol and the Dollar symbol is a perfectly valid character in the local-part. Domkey is required to generate a Dombox. A Dombox is a property of both the User identified by Domkey and the Dombox Domain. Only the “Dombox Domain” and it's “SAD Domains” can write emails to the “Isolated Mailbox”. Only the consumer can read and delete emails from the “Isolated Mailbox”.

### 3. Dombox Address Structures

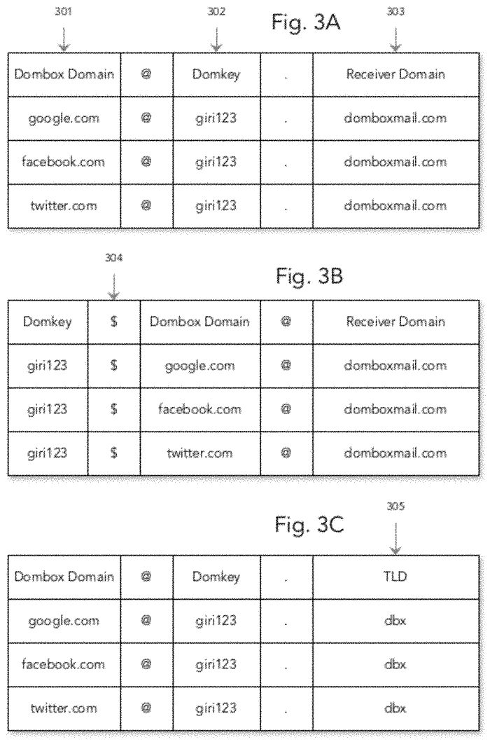

Isolated Mailbox (i.e. Dombox) has three different address structures. FIG. 3A illustrates subdomain-based Dombox email address structure. FIG. 3B illustrates Dollar-based Dombox email address structure. FIG. 3C illustrates Custom-TLD based Dombox email address structure.

Dombox email address structure contains of the following things. Dombox Domain, Domkey and Receiver Domain

The term “Dombox Domain” 301 refers to the “Service Domain”. A Dombox is created for only that particular “Dombox Domain”. By default only the “Dombox Domain” is authorized to send mails to that particular Dombox. “Dombox Domain” can be found between the “$” symbol and “@” symbol in the dollar-based Dombox email address structure. The whole “local-part” in the sub-domain based dombox address structure and the whole “local-part” in the Custom-TLD based dombox address structure contains the “Dombox Domain”. The term “Dombox Domain” is applicable only to the boxes found in “Domboxes” group. Some people may be confused with our official domain “domboxmail.com”. In such situations, the term “Box Domain” or “Service Domain” should be used instead of “Dombox Domain”. In other words, “Box Domain”, “Dombox Domain” and “Service Domain” refers to the same thing. Only the “main domain” is allowed in “Dombox Domain”. e.g. example.com. All subdomains are converted into main domain. e.g. If a user tries to create a box for https://del.icio.us, then the box will be created for “icio.us” because that's the main domain.

The term “Domkey” 302 refers to the short form “Dombox Global Keyword”. Domkey should be a unique string just like username. Domkey should be an alphanumeric string. Domkey can be set only once for an account and cannot be changed later. e.g. giri123. Throughout this document “giri123” refers to a Domkey. Domkey should be set before creating the first “Dombox”. Domkey is same for all user created Domboxes. Domkey cannot be one of user's “Normal Mailbox” local-part. i.e. If a user has an email address like johndoe@domboxmail.com, then the user can't have “johndoe” as value for Domkey.

The term “Receiver Domain” 303 refers to the mail receiving domain. Throughout this document domboxmail.com is used as receiver domain.

FIG. 3A illustrates subdomain-based Dombox email address structure and its examples.

Address Structure: {Dombox Domain}@{Domkey}.{Receiver Domain} 204. e.g. example.com@giri123.domboxmail.com. Domkey 302 acts as a subdomain in FIG. 3A

FIG. 3B illustrates dollar-based Dombox email address structure and its examples.

Address Structure: {Domkey}{Separator}{Dombox Domain}@{Receiver Domain}. e.g. giri123$example.com@domboxmail.com. In dollar-based Dombox email address structure, local-part is divided into three parts. Domkey, Separator 304 and Dombox Domain.

The term “Separator” 304 is a special character that separates “Domkey” and the “Dombox Domain”. The separator should be same and consistent for all dombox addresses. The separator should be a valid special character allowed in email address local-part. e.g. $ (Dollar symbol). Throughout this specification $ symbol is being used as Separator.

FIG. 3C illustrates Custom-TLD based Dombox email address structure and its examples

Address Structure: {Dombox Domain}@{Domkey}.{TLD}. e.g. example.com@giri123.dbx “dbx” 305, is an example custom TLD created to provide Dombox mail service. In this example “Second Level Domain” is considered as “Domkey”

This specification uses both “Dollar-based” and “Subdomain-based” address structures interchangeably in examples and illustrations.

Our Dombox address structures explicitly shows “Dombox Domain” and Domkey on the email addresses. “Dombox Domain” is the service identifier. Domkey is the user identifier. A system can also go for implicit method. I.e. Service Identifier, User identifier etc. mapped indirectly using a database. E.g. Table rows on the database may have a structure like this for the Dombox Addresses.

Dombox Address: abc@domboxmail.com, Service Identifier: example.com, User Identifier: giri123, Alias Domains: example.net, example.org

Dombox Address: xyz@domboxmail.com, Service Identifier: 12345, User Identifier: giri123, Allowed Domains: example.net, example.org

Both abc@domboxmail.com and xyz@domboxmail.com looks like normal mailbox addresses, but they are actually isolated mailbox addresses since mapped using a database. Using Hashes (e.g. MD5, SHA1, SHA256) to identify domain is another indirect approach

The reason we use “Dombox Domain” explicitly because we want third-party newsletter services like mailchimp identify the service easily. For example, quora.com@giri123.domboxmail.com address belongs to quora.com. Mailchimp can ask the logged in user (i.e. business owner) to verify quora.com So spammers can't abuse third party newsletter services to send spam. This kind of explicit address structures saves a lot of bandwidth and computing power on both sides.

### 4. Architecture

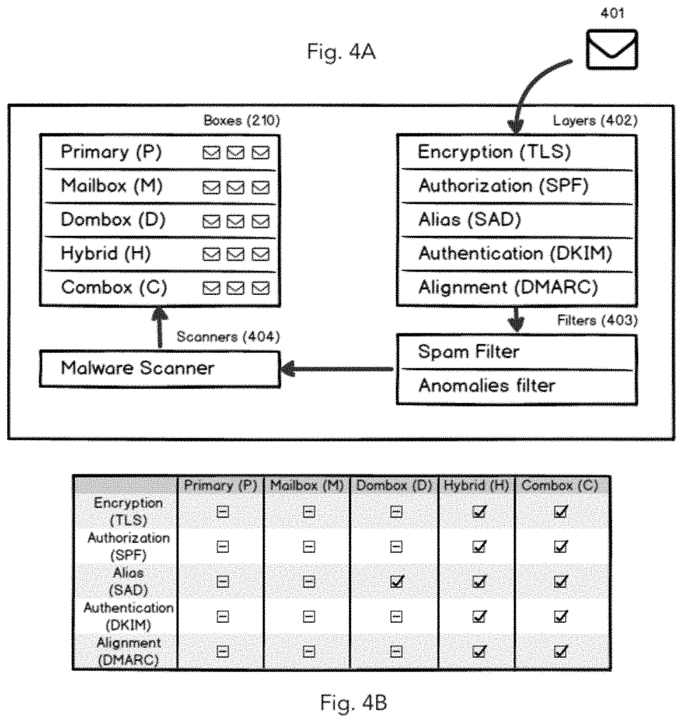

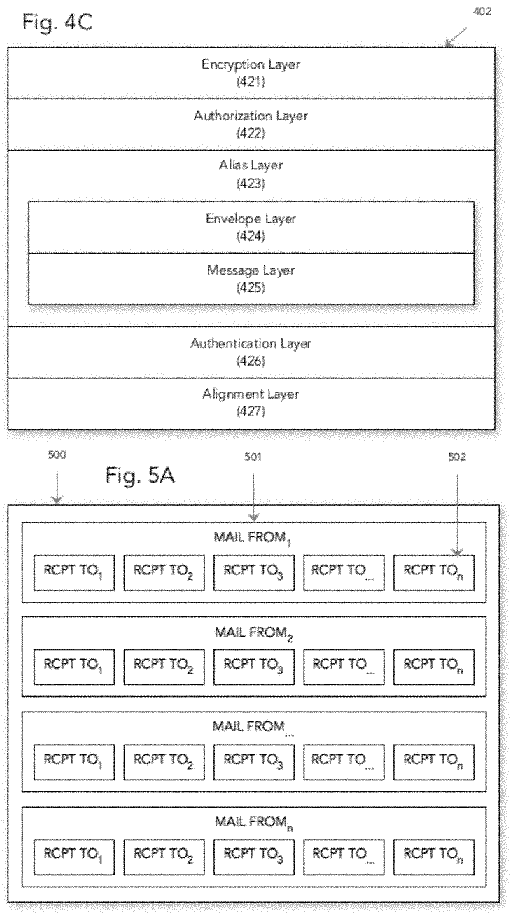

FIG. 4A illustrates the Dombox mail system architecture. Our system contains 4 major components. Layers 402, Filters 403, Scanners 404 and Boxes 210. Layers 402 component contains 5 layers. Spam mails usually get caught in one of these layers. Filters 403 component contains 2 Filters. Spam Filter & Anomalies Filter. Spam Filter is the normal spam filter. Anomalies Filter is a less aggressive spam filter and it's primarily targets Phishing and Malware mails. Scanners 404 component contains virus and malware scanners. Boxes 210 component contains 5 types of boxes. Each box type is designed for a different purpose.

FIG. 4C illustrates the layers. Each and every incoming mail has to go through five layers of checks. Those five layers are Encryption Layer 421, Authorization Layer 422, Alias Layer 423, Authentication Layer 426 and Alignment Layer 427. Alias Layer contains two sub layers. Envelope Layer 424 and Message Layer 425. Spam mails usually get caught in one of these 5 layers. So the mail will be rejected instantly.

### 5. Layers

FIG. 5A illustrates a mail session structure. A mail session can have unlimited messages 501. Each message can have unlimited recipients 502. MAIL FROM1 to MAIL FROMn 501 command represents the beginning of each message. RCPT TO1 to RCPT TOn 502 command represent recipients of that particular message.

FIG. 1A illustrates a simple SMTP conversation between two mail servers. mail.example.com is connecting to mail.domboxmail.com with its IP address 102. This process known as TCP handshake. The “Client IP” (Mail Sending Server IP/Connection IP) address is extracted from here. The C letter in FIG. 1A represents the Client (Mail Sending Server). In our case this is mail.example.com. The S letter in FIG. 1A represents the Server (Mail Receiving Server). In our case this is mail.domboxmail.com. The Server responds with 220 code 103 if the server is ready. This 220 response is known as SMTP banner. The Client issues the HELO/EHLO 104 command to identify itself. The domain found in the HELO/EHLO command is known as HELO Domain/EHLO Domain. In this case, the HELO domain is mail.example.com. The Server responds with 250 code to acknowledge. The Client issues the MAIL FROM 106 command to specify the sender. This command tells that a new mail transaction is being started. The email address provided by the MAIL FROM command is also known as Envelope From, Return Path, RFC.5321 From and Bounce Address. The Server responds with 250 code when there is no problem with the MAIL FROM address. The Client issues the RCPT TO 108 command to specify the receiver mail address. The mail will be delivered to the email address provided in this command. The Client may issue RCPT TO command multiple times to deliver the mail to more than one recipient. The Server responds with 250 code for each RCPT TO command if the recipient is valid. The Client issues the DATA 110 command to transfer the message contents (body text, attachments etc). The Server responds with 354 code to proceed to transfer the message contents. The Client transfers the message contents (mail headers, body text, attachments etc). The whole contents transferred here is called “Message Part”. The headers found in the message contents are called “Message Headers”. The “From” email address 114 found in the message header is called “Message From”. It is also known as “RFC.5322 From” and “Display From”. Message Headers can also contain additional headers like DKIM-Signature 116. The Server responds with 250 code and queue the message for delivery 118. The Client issues the MAIL FROM command again if there are more mails to transfer, otherwise it issues the QUIT command to close the connection. The Server responds with 221 code and closes the connection.

5.1. Layer Purpose

Each layer serves a different purpose.

(i) Encryption Layer—Checks whether the mail is encrypted.
(ii) Authorization Layer—Checks whether the “Sending IP/Client IP” is authorized to send mails for the “Envelope Domain”. When “Envelope Domain” is not available HELO/EHLO domain is used.
(iii) Alias Layer—Checks whether the “Envelope Domain and/or Message Domain” is an alias for the “Dombox Domain”.
(iv) Authentication Layer—Checks whether the mail is digitally signed and the digital signature valid.
(v) Alignment Layer—Checks whether the “Envelope Domain and/or Signature Domain” is aligned with “Message Domain”

### 5.2. Primary Subject

(i) Encryption Layer—None (ii) Authorization Layer—Envelope Domain (iii) Alias Layer—Dombox Domain (iv) Authentication Layer—Signature Domain (v) Alignment Layer—Message Domain

### 5.3. Record Path

(i) Encryption Layer—None (ii) Authorization Layer—dig TXT envelopedomain.com (iii) Alias Layer—dig TXT_sad.domboxdomain.com (iv) Authentication Layer—dig TXT selector._domainkey.signaturedomain.com (v) Alignment Layer—dig TXT dmarc.messagedomain.com

### 5.4. Technical Names

(i) Encryption Layer—Transport Layer Security (TLS) (ii) Authorization Layer—Sender Policy Framework (SPF) (iii) Alias Layer—Sender Alias Domains (SAD) (iv) Authentication Layer-DomainKeys Identified Mail (DKIM) (v) Alignment Layer—Domain-based Message Authentication, Reporting and Conformance (DMARC)

### 5.5. Encryption Layer

Checks whether the mail is encrypted. Technical Name: Transport Layer Security (TLS). Possible Results: Pass or Fail. Pass—Encrypted. Fail—Not Encrypted

### 5.6. Authorization Layer

Checks whether the “Sending IP/Client IP” is authorized to send mails for the “Envelope Domain”. When “Envelope Domain” is not available HELO/EHLO domain is used. Technical Name: Sender Policy Framework (SPF). Possible Results: Pass or Neutral or Fail. Pass-Authorized. Neutral—Not Configured. So neither Authorized nor Unauthorized. Fail-Unauthorized.

Note: We use SPF in our authorization layer because it is the popular standard. There are alternatives available too. Like Microsoft Sender ID. So it has to be noted, authorization layer deals with authorized IP addresses of the Envelope Domain. SPF is one of the implementations. Also Note: MAIL FROM address can be empty. e.g. bounce mails. In such cases, the SPF record will be pulled from the HELO/EHLO domain.

### 5.7. Alias Layer

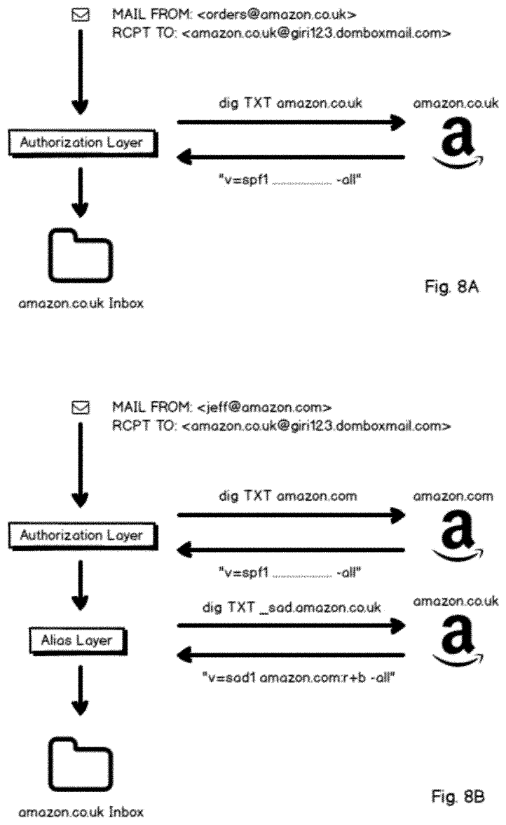

Checks whether “Envelope and/or Message Domain” is an alias for the “Dombox Domain”. Technical Name: Sender Alias Domains (SAD). Possible Results: Pass (FakePass, DirectPass, IndirectPass). (i) FakePass—Alias Layer applicable only for “Domboxes”. So if the incoming mail is to the boxes found in “Mailboxes” group, then the result is set to “FakePass” for consistency. (ii) DirectPass—When the “Envelope and/or Message Domain” are the same as “Dombox Domain”. FIG. 8A illustrates Direct Pass. (iii) IndirectPass—When the “Envelope and/or Message Domain” are not the same as “Dombox Domain”, but passed via SAD record. FIG. 8B illustrates Indirect Pass. Note: If the Alias Layer result is “Fail”, then the mail will be rejected. So the only possible result for “Alias Layer” is “Pass”.

Alias layer is divided into two sub layers. (i) Envelope Layer—Checks whether the “Envelope Domain” is an alias for the “Dombox Domain”. (ii) Message Layer—Checks whether the “Message Domain” is an alias for the “Dombox Domain”

Alias Layer is all about 3 domains. Dombox Domain (Primary Subject) compares itself with “Envelope Domain” and “Message Domain”. Keep in mind, this layer contains two checks. One for the “Envelope Layer” and One for the “Message Layer”. Even if one Layer result is “Fail”, then the mail will be rejected. Alternatively, we can disable the “Message Layer” check.

### 5.7.1. Sender Alias Domains (SAD)

SAD is similar to SPF. SPF deals with “authorized IP addresses”. SPF record is provided by the “Envelope Domain”. In SPF, We check whether the “Client IP” is found in the list of “authorized IP addresses” provided by the “Envelope Domain”.

SAD on the other hand, deals with “authorized domains”. SAD record is provided by the “Dombox Domain”. In SAD, We check whether the “Envelope Domain/Message Domain” found in the list of “authorized domains” provided by the “Dombox Domain”.

For example, A user created an isolated mailbox for amazon.in and the box address looks like this=>giri123$amazon.in@domboxmail.com. This box can accept mail only from amazon.in by default. To allow mail from jeff@amazon.com to amazon.in box, amazon.in should have the following SAD record in_sad.amazon.in. “v=sad1 amazon.com:r+b example.com:s+e-all”. Note: We always check the SAD record in the “Dombox Domain”. The “Dombox Domain” can be extracted from the Isolated Mailbox address. giri123$amazon.in@domboxmail.com=>amazon.in

Note: While we use SAD for whitelisting Envelope and Message Domains. We can also use SAD for whitelisting any kind of domains. E.g. HELO/EHLO Domain, DKIM Domain etc.

### 5.7.2. SAD Configuration

A SAD record can have multiple domains and each domain can have a configuration.

### {Domain}:{Relaxed or Strict}+{Envelope Mode or Message Mode or Both}

(i) Relaxed (r)—Exact domain and its subdomains are allowed (Default).
(ii) Strict (s)—Exact domain only allowed.
(iii) Envelope Mode (e)—Domain is allowed only in the “Envelope From” (Default).
(iv) Message Mode (m)—Domain is allowed only in the “Message From”.
(v) Both Mode (b)—Domain is allowed in “Envelope From” as well as “Message From”.

So, “v=sad1 example.com-all” is equivalent to “v=sad1 example.com:r+e-all”

### 5.7.3. SAD Examples ED=Envelope Domain, MD=Message Domain, DD=Dombox Domain

Box created for facebook.com (DD), mails are carried by third-party newsletter service mailchimp.com (ED) for the domain facebook.com (MD). In this case, add the following record in “Dombox Domain” DNS.

_sad.facebook.com=>“v=sad1 mailchimp.com-all”

Box created for facebook.com (DD), mails are carried by facebook.com (ED) for one of their product instagram.com (MD). In this case, add the following record in “Dombox Domain” DNS.

_sad.facebook.com=>“v=sad1 instagram.com:r+m-all”

Box created for facebook.com (DD), mails are carried by third-party newsletter service mailchimp.com (ED) for one of Facebook product instagram.com (MD). In this case, add the following record in “Dombox Domain” DNS.

_sad.facebook.com=>“v=sad1 mailchimp.com instagram.com:r+m-all”

### 5.7.4. SAD Types

Three kinds of SAD available: (1) Box SAD (2) Local SAD (3) Global SAD

### 5.7.4.1. Box SAD

Problem: A system would fail when it expects immediate total cooperation from everybody at once. We cannot expect the websites to support SAD record in our early years. On the other hand, we cannot just assume that the websites gonna use only their “Dombox Domain” to send mails. For example, Facebook always sends their notification mails from facebookmail.com. So, If you create a box for “facebook.com”, it won't accept those notification mails from facebookmail.com unless SAD is configured.

Solution 1: Let the box learn from its initial users. e.g. 100 Users. We are gonna give unrestricted access to the box for X days for the first X users who create the box. e.g. 30 days.

Example: You created an isolated mailbox for randomdomain.com and you are one of the first 100 Users. For the first 30 days the box gonna work like a Normal Mailbox. i.e. It can accept mails from any domain. The box aggregates and generates a SAD record from those first 100 Users. Pros: After 100 Users we have enough data for SAD. Cons: First 100 users can abuse the system by creating duplicate accounts in 3rd party websites. We should have maximum SAD Domains to minimize such abuse. e.g. 10

Solution 2: Collect SAD data from user other mail account mails. e.g. @gmail.com, @outlook.com

Solution 3: Purchase the SAD data from data mining companies. Since SAD record contains only non sensitive public data, this is totally ethical.

Message Domain=>Array of Envelope Domain.=>Total Mails and Total Users for each Envelope Domain. e.g. acme.com=>array(“mailchimp.com”=>“found 573 mails in 33 user accounts”, “sendgrid.net”=>“found 273 mails in 13 user accounts”)

The SAD in this section can be termed as “System authorized SAD”.

### 5.7.4.2. Local SAD

This is the SAD Record added by our company staff for the notable domains. We should have a threshold for a domain to be considered as a notable domain. e.g. 10 million users. Our staff would collect the data from various sources and then define the SAD Record. This may sound like a tedious process, but it actually is not due to the following reasons.

(i) Unlike SPF (which deal with IP addresses), we are dealing with only the “domain names” in SAD. So the data is a stable one since rarely it get changed. Once a SAD record added by our staff, no need to intervene until there is a problem. (ii) We can cover most of these notable domains if we process old emails from Gmail, YahooMail etc. So we can ask our users to import their old emails. (iii) We can contact these notable sites directly and collect the data from them. (iv) All these notable sites, usually have their own mail server setup and do not depend on third party mailing services to send out mails. So they usually use the “reject” policy in DMARC record. Which means there won't be any SAD Domains for such sites except in rare cases like Facebook.

The SAD in this section can be termed as “Staff authorized SAD”. The staff is a natural person.

### 5.7.4.3. Global SAD

This is the SAD record defined in the “Dombox Domain” DNS by the domain owner in this path. _sad.domboxdomain.com

Sender Alias Domains (SAD) and the “Alias Layer” is applicable only to our dombox mail system. Although we recommend SAD record to be placed in a DNS server, there are other ways to achieve the same result too. For instance, Google has thousands of domains. It's really not possible to place these thousands of domains in the DNS due to the limitation. So the SAD record that contains these thousands of domains can be placed in an HTTP or HTTPS server (i.e. web server) as a txt file. For example google.com can provide their SAD record by placing it in path like http://google.com/sad.txt or https://google.com/sad.txt.

However, it is also possible to ask the domain owners to create an account on our system and verify their domains and then ask them to provide their SAD domains by displaying an HTML form input field. This kind of system offers benefits to only one entity and it's really impossible to ask all 332 million domains to create an account, verify their domains and provide the SAD domains. The SAD in this section can be termed as “Service authorized SAD”. More Specifically it's authorized by a “Service Administrator” or “Service Owner”.

We can ask domain verification for the primary domain and/or all the SAD domains provided by the domain owner. The domain can be verified by placing a TXT record in the DNS or a text file in a HTTP(S) server or even sending a verification email to an email address that ends with the same domain.

### 5.7.4.4. User SAD

A user can authorize one or more domains to send mails to the particular dombox. But users can abuse this kind of system. Also it's a daunting task for non technical users. For that reason, our system does not support “User authorized SAD” at the moment. But it is possible.

FIG. 7 illustrates the logical flow of SAD record selection.

### 5.7.5. Notes for Bulk Mailers

The SAD record will be checked when you issue RCPT TO 108 command. When you issue multiple RCPT TO commands (i.e. multiple recipients) make sure they are all related to the same “Dombox Domain” for better results. To prevent DDoS attacks, we allow up to 10 SAD record failures. The whole session will be terminated with an error message like “Too many SAD Failures” if there are more than 10 SAD record failures. If the Alias Layer is Fail for a “Dombox Domain”, then all consecutive RCPT TO commands related to that “Dombox Domain” will result in Failure too. So if you get a response like “Alias Layer Failure”, then either terminate the session or move on to the next “Dombox Domain”. Avoid sending mails to more than 100 different “Dombox Domains” in a single session. Note: The values 10 and 100 used here as example values.

### 5.7.6. SAD Record Query

The SAD record will be fetched from the Dombox Domain.

dig TXT_sad.domboxdomain.com

### 5.7.7. Alias Layer Flowcharts

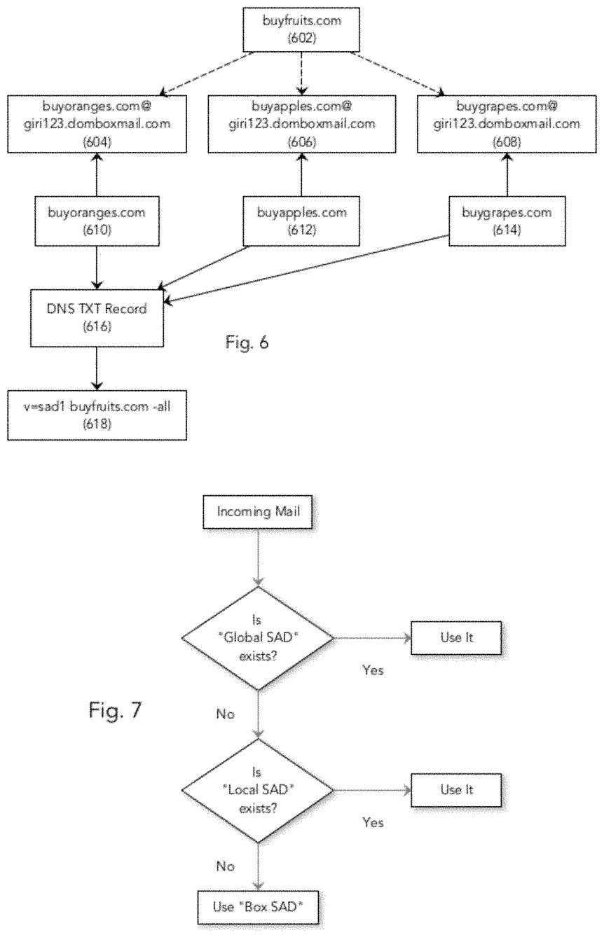

FIG. 6 illustrates the logical flow of SAD. BuyFruits.com 602 is a company that sells fruits. This is the parent company. But it also has three subsidiaries BuyOranges.com 610, BuyApples.com 612, BuyGrapes.com 614. When a user create Dombox for BuyOranges.com, the dombox address will be buyoranges.com@giri123.domboxmail.com 604. For this Dombox, only the mails from BuyOranges.com are allowed. When a user create Dombox for BuyApples.com, the dombox address will be buyapples.com@giri123.domboxmail.com 606. For this Dombox, only the mails from BuyApples.com are allowed. When a user create Dombox for BuyGrapes.com, the dombox address will be buygrapes.com@giri123.domboxmail.com 608. For this Dombox, only the mails from BuyGrapes.com are allowed. There should be a way for the parent company to send mails to subsidiary company users. e.g. A mail from the parent company CEO (ceo@buyfruits.com) to the subsidiary company users. We solve this problem with our standard called Sender Alias Domains (SAD). SAD is applicable only for Domboxes 202. SAD should be placed in the “Dombox Domain”. buyapples.com@giri123.domboxmail.com where buyapples.com is the “dombox domain”. So the SAD should be placed in buyapples.com. The SAD structure would look like this. “v=sad1 buyfruits.com-all”. If the above string found in buyapples.com DNS record 616, that would allow mails from @buyfruits.com to the Dombox buyapples.com@giri123.domboxmail.com. In other words, although the box created only for buyapples.com, it can receive mails from buyfruits.com. If SAD records not found in DNS, then we allow only the Dombox Domain “buyapples.com” to send emails to the user. “v=sad1 buyfruits.com-all” 618 SAD Record is defined in all three subsidiary domains DNS 616. i.e. BuyOranges.com 610, BuyApples.com 612, BuyGrapes.com 614. So buyfruits.com 602 now can send mails to subsidiary domain users. Because buyfruits.com is a “Sender Alias Domain” for the subsidiary domains. In FIG. 6 dotted arrows represent indirect mail delivery. i.e. via a Sender Alias Domain.

As of now the SAD Records are duplicated in subsidiary domains. i.e. The same SAD Record present in all three subsidiary domain DNS. SAD Record can be managed in only one place with the help of “redirect” tag. We can place the main SAD Record “v=sad1 buyfruits.com-all” in _sad.buyfruits.com and then in all subsidiary domains we can use the following SAD Record. “v=sad1 redirect:_sad.buyfruits.com”. Now all the subsidiary SAD queries are redirected to _sad.buyfruits.com. If we add more domains in the future, we don't have to edit each and every subsidiary domain. We have to only edit the main SAD.

We can also have “include” tag. This will include the external SAD. “v=sad1 example1.com-all” Record is placed in _sad.abc.com and “v=sad1 example2.com-all” Record is placed in _sad.xyz.com. Now we can use the “include” tag to include those SAD. “v=sad1 include:_sad.abc.com include:_sad.xyz.com-all”. If that SAD found in a domain, that would allow both example1.com and example2.com. There is a maximum of 10 DNS lookups in order to avoid DDoS attacks.

Both “include” and “redirect” options will be helpful when a service relies on third party services to send mails. Third-party newsletter services like mailchimp use their own custom domain for “Envelope Domain” to generate VERP. bounce-mc.us3_7667677.3535173-domboxtester=gmail.com@mail144.at1221.rsgsv.net The following are some of the “Envelope Domain” mailchimp uses in the MAIL FROM command. mcsv.net, mcdlv.net, or rsgsv.net. Unless mailchimp explicitly states this information in their documentation, website owners will have no idea. And mailchimp may add more domains in the future. So instead of asking the website owners to add these domains manually, they can configure a SAD record in the following path._sad.mailchimp.com=>“v=sad1 mcsv.net mcdlv.net rsgsv.net-all”. And then ask the website owners to “include” or “redirect” to _sad.mailchimp.com

In some cases, the business owner would like to have a single “Dombox Domain” for all their domains. For example, Google owns thousands of domains like blogger.com, googleplus.com, youtube.com etc. google.com is the main domain. Google would like to use the main domain for creating dombox when users try to create dombox for googleplus.com. In such cases, Google can configure the SAD record in googleplus.com like this.

_sad.googleplus.com=>“v=sad1 box:google.com-all”.

The “box” keyword says, create a dombox for google.com instead of googleplus.com. So the addresses would look like giri123$google.com@domboxmail.com instead of giri123$googleplus.com@domboxmail.com. When the user tries to create a dombox for googleplus.com, we will fetch the SAD record from the googleplus.com DNS. If the “box” option is found in the googleplus.com SAD record, we will use the domain specified in the box option for creating the dombox. Otherwise we will fallback to the current passed domain. We can display a popup saying:

“You are trying to create a dombox for googleplus.com. However, googleplus.com suggests creating the dombox for google.com. Would you like to continue? (a) Yes, create dombox for google.com (b) No, create dombox for googleplus.com”

### 5.7.8. Sender Alias Addresses (SAA)

Our Alias Layer deals with only the “domain” part of the “Envelope From” and “Message From” email addresses. I.e. Envelope Domain and Message Domain. The system can also be configured to deal with full email addresses. In this case the “Dombox Domain” may authorize full email addresses via SAD. I.e. Sender Alias Addresses (SAA). E.g. “v=saa1 hello@example.com test@acme.com:e-all”

When the “Alias Layer” relies only on full email addresses, then the system will fail for the following reasons. Let's divide the SAA into two parts just like SAD. Envelope SAA and Message SAA.

Envelope SAA will fail primarily because third-party newsletter services like mailchimp uses Variable Envelope Return Path (VERP). I.e. The “Envelope From” email address will be unique for each and every recipient. And it's generated by the mailchimp system on the fly. It's really impossible for the domain owners to know these addresses beforehand. Here is an example VERP. bounce-mc.us3_7667677.3535173-domboxtester=gmail.com@mail144.atl221.rsgsv.net

You won't have this kind of problem in SAD. The VERP address would work flawlessly in SAD if it looks like this. “v=sad1 rsgsv.net:r+e-all” or “v=sad1 mail144.atl221.rsgsv.net:s+e-all”. The first SAD uses relaxed configuration. The second SAD uses strict configuration. So the mail will be accepted in both cases.

Message SAA will fail because (1) whitelisting each and every “Message From” address in the SAA is impossible for domain owners. (2) Bigger companies like amazon has plenty of “Message From” addresses for their domain amazon.com (3) It's really impossible to manually whitelist every new email addresses (4) The system needs to rely on signature mechanism like DKIM in order to prove “Message From” genuinity. (5) Unlike SPF, DKIM is complicated for non-tech savvy domain owners since it deals with Public and Private keys (6) DKIM signatures are included in the email Message Headers. So it can be stripped by a middle-man.

### 5.7.9. Receiver Policy Framework (RPF)

In the Alias layer, Dombox Domain (Primary Subject) compares itself with “Envelope Domain” and “Message Domain”. And SAD Domains are pulled from the “Dombox Domain” DNS. A domain name is nothing but a human readable network address. An IP address is a machine readable network address. A domain actually gets translated to one or more IP addresses. I.e. The whole point of “SAD” is about identifying one or more “authorized servers” authorized to send mails for the “Dombox Domain”. So SAD record can be used for whitelisting (i.e. authorizing) “IP addresses” rather than “domains”.

When we use “IP addresses” for SAD, then it's nothing but a replica of “Sender Policy Framework (SPF)”. The only difference is that SPF is used in the “MAIL FROM” command. But SAD is associated with the RCPT TO. i.e. We pull the SAD record during the RCPT TO command using the “Dombox Domain”. So the standard can be termed as “Receiver Policy Framework (RPF)”. It has to be noted that, SPF record is only once per message 501. But we may have to pull RPF records multiple times since there will be multiple recipients 502.

Simply put, we are gonna pull a DNS record from the “Dombox Domain” as usual during RCPT TO command. But the SAD record (i.e. RPF record) will be a list of IP addresses rather than domain names. The “Client IP” 102 will be compared with the list of “Authorized IP addresses” provided by “Dombox Domain”.

We can use the exact SPF specification and SPF configuration for RPF. RPF records can be placed in this location._rpf.domboxdomain.com

### 5.7.10. Sender Alias Hashes (SAH)

Rather than asking for domains and IP addresses, a system can be configured to ask for domain and IP hashes. In that case the system should be treated equally. Because Hash is being used here to mask the real information.

Real SAD: _sad.facebook.com=>“v=sad1 mailchimp.com instagram.com:r+m-all”. Masked SAD: _sad.facebook.com=>“v=sad1 647c5fe1060e7ef85eb2733a230abff8 8dc6460bbbb088757ed67ed8fb316b1b:r+m-all”. 647c5fe1060e7ef85eb2733a230abff8 is the md5 hash of mailchimp.com. 8dc6460bbbb088757ed67ed8fb316b1b is the md5 hash of instagram.com

Real RPF: _rpf.facebook.com=>“v=rpf1 ipv4:127.0.0.1 ipv4:127.0.0.2-all”. Masked RPF: _rpf.facebook.com=>“v=rpf1 ipv4:f528764d624db129b32c21fbca0cb8d6 ipv4:ab416c39d509e72c5a0a7451a45bc65e-all”. f528764d624db129b32c21fbca0cb8d6 is the md5 hash of 127.0.0.1. ab416c39d509e72c5a0a7451a45bc65e is the md5 hash of 127.0.0.2

### Email Address:

In some cases, the service owner would like to allow only an email address via SAD. For example, the owner of acme.com has a mail address johndoe@gmail.com. We don't consider gmail.com as a valid SAD domain since that would allow every gmail user to send mail to the service. However, we can allow email addresses. “v=sad1 johndoe@gmail.com giri@gmail.com-all”. The last SAD record allows 2 email addresses. Since SAD records are usually hosted in either DNS or a web server, anyone can see the email address, scrap it and send spam mails. So we accept email addresses as hashes rather than plain email addresses. i.e. “v=sad1 e: 29a1df4646cb3417c19994a59a3e022a e:feb33ed1ca09bc74f6688e6fb5536aa1-all”. The “e” before the colon says that the hash is an email address hash.

### 5.7.11. Split SAD

Our Alias Layer contains two sub layers. Envelope Layer and Message Layer. We perform SAD check for Envelope Layer (Envelope SAD) and one more SAD check for Message Layer (Message SAD). We use a single DNS record to perform both checks._sad.facebook.com=>“v=sad1 mailchimp.com instagram.com:r+m-all”. A system can go two different SAD records. One for Envelope SAD (ESAD) and one for Message SAD (MSAD)._esad.facebook.com=>“v=esad1 mailchimp.com-all”._msad.facebook.com=>“v=msad1 instagram.com-all”

Also note that, it is possible to whitelist other domains like HELO/EHLO domains and DKIM Domain in the SAD records.

### 5.7.12. SPF Fallback

When the SAD record is not configured we allow only the “Dombox Domain” to send emails to the dombox address. E.g. User creates a dombox address for twitter.com. The address looks like this. twitter.com@test123.domboxmail.com

The above address cannot accept any mails from non dombox domain unless SAD record is configured. I.e. This domain can accept mails from twitter.com, but not from twitter.org unless twitter.org is whitelisted in _sad.twitter.com. E.g. “v=sad1 twitter.org-all”

It's really not possible to convince every domain to configure the SAD record since it is something new. So When the SAD record is not found, we can fallback to the SPF record. We check the SAD record in the “Dombox Domain”. If found we just check whether domains like “Envelope Domain” are found in the SAD record. If no SAD record is configured, then we fetch the SPF record of “Dombox Domain”.

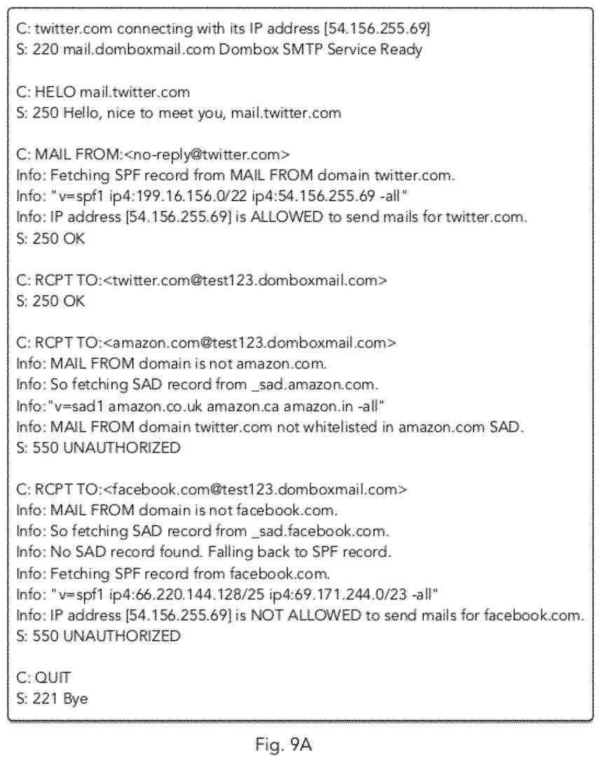

FIG. 9A illustrates the SAD layer validation process. It illustrates how we fallback to SPF record when the SAD record is not available.

### 5.7.13. Authorization Hierarchy

Dombox Address: amazon.in@giri123.domboxmail.com

Dombox Domain: amazon.in

SAD Record: _sad.amazon.in =>“v=sad1 amazon.com amazon.co.uk-all”

Dombox mail address authorizes the domain amazon.in. Amazon.in authorizes additional domains via SAD. So from the “Dombox mail address” perspective, authorized domains are “amazon.in, amazon.com, amazon.co.uk”

OAuth based apps are usually identified via Client ID. So the address structures might look like this. {ClientID}@domkey.domboxmail.com. In other words, there is no “Dombox Domain” here. So the SAD is directly linked here with the dombox mail address. Service Owner or Service Manager may provide the SAD while registering an oauth application.

### 5.8. Authentication Layer

This layer checks whether the mail is digitally signed and the digital signature valid. Technical Name: DomainKeys Identified Mail (DKIM). Possible Results: Pass or Neutral or Fail. Pass-Digitally Signed and Signature Verification Passed. Neutral—Digitally not Signed. Fail—Digitally Signed, but Signature Verification Failed. Note: This layer uses DKIM since it is the most popular one as of now. Identified Internet Mail (IIM) and Yahoo's DomainKeys were merged and formed the basis for DomainKeys Identified Mail (DKIM). So this layer shouldn't be limited to DKIM. Any cryptography-based signing and signature verification mechanism for validating mails applicable here.

### 5.9. Alignment Layer

Checks whether “Envelope Domain and/or Signature Domain” is aligned with “Message Domain”. Technical Name: Domain-based Message Authentication, Reporting and Conformance (DMARC). Possible Results: Pass or Neutral or Fail. Pass—Domains are aligned. Neutral-Domains are not aligned, but the “Message Domain” either has “No Objection” or no valid DMARC record found in the “Message Domain”. Fail—Domains are not aligned and the “Message Domain” has “Objection”

“You can send mails for the domain you don't own”. That's what the third-party newsletter services like mailchimp doing right?. So what's stopping the spammers from misusing your domain? If you own a domain called abcd.com, what's stopping spammers from sending “Viagra” mails from email address like no-reply@abcd.com?. This is called Email Spoofing. Many spammers use the spoofing method to send Phishing mails. Companies like PayPal had been a major victim of Phishing mails in the past. Companies like PayPal, your banking website etc. can't afford when spammers misuse their domain. Hence DMARC came to the rescue.

This layer protects the “Message Domain”. This Layer is all about 3 domains too. In Alias Layer, Dombox Domain (Primary Subject) compares itself with “Envelope Domain” and “Message Domain”. Purpose: To “Allow” third party domains. Just like that, In Alignment Layer, Message Domain (Primary Subject) compares itself with “Envelope Domain” and “Signature Domain”. Purpose: To “Deny” third party domains.

When all three domains look exactly the same, then it's already aligned. We just accept the mail. But if there is even a small change (e.g. subdomain) or completely different domains used, then we need to ask the “Message Domain” about how we should treat the mail. If there is no DMARC record found in the “Message Domain” DNS, then the ball is in our court. So we use our version of the book to play the game. If a DMARC record found in the “Message Domain” DNS, then we should treat the mail as they say. This is called DMARC policy. The policy can be one of the three things. None, Quarantine or Reject

Policy: None, Meaning: Do whatever you want. Policy: Quarantine, Meaning: Put in the spam folder. Policy: Reject, Meaning: Reject the mail immediately

The following DMARC record is what PayPal has in its DNS at this location=>_dmarc.paypal.com

“v=DMARC1; p=reject; rua=mailto:d@rua.agari.com; ruf=mailto:d@ruf.agari.com”

We actually wanted to call this layer “Objection Layer”. This is because this layer is all about asking a question to the “Message Domain”. Hey “Message Domain”, The domains are not aligned. But our server is going to accept this mail. Do you have any objections? The response will be one of the following.

(i) Policy: None, Meaning: I have no objection, Result: No Objection. (ii) Policy: Quarantine, Meaning: Yes I have objection . . . Put in the spam folder, Result: Objection. (iii) Policy: Reject, Meaning: Yes I have objection . . . Reject the mail immediately, Result: Objection. (iv) Policy: No Record, Meaning: I don't know what you are talking about, Result: No Objection

From the last table, we can come to a conclusion, a “Message Domain” can have either objection or no objection. We can mark this layer as “Pass” when domains are aligned. We can mark this layer as “Fail” when the “Message Domain” has “Objection”. i.e. Quarantine or Reject. We can mark this layer as “Neutral” when the “Message Domain” has “No Objection”. i.e. None or No Record.

However, we need a small change for the incoming mails to the boxes found in “Domboxes” group. In Domboxes, We should mark this layer as “Pass” when the “Message Domain” has “No Objection”. i.e. None or No Record. As of 2018, 332 million domains are registered so far. In “Mailboxes” case, receiving mail is like opening a can of worms. The DMARC is the “Iron Grip”. So it gives us clarity. i.e. 332 million domains can send mail to the mailbox. In the “Domboxes” case, only the “Dombox Domain” and it's “SAD Domains” can send mails to the Dombox. So we are talking about only a handful of domains here. But still, we need to make sure that the Message Domain has no Objection, before accepting the mail. For example, if a domain owner configured an SAD record like this “v=sad1 paypal.com:r+m-all”, then we shouldn't just take his word for it. So if there is no DMARC record found in the “Message Domain”, then we take the “Dombox Domain” owner's word for it. Because we are hoping they won't ruin their domain reputation by whitelisting domains in their SAD record for email spoofing. Our point is that “Alignment Layer” can be “Neutral” in “Mailboxes”. But can't be in “Domboxes”. Because if there is no DMARC record found or None value configured then we just accept the mail by marking the result as “Pass”

### 5.10. Possible Results

(i) Encryption Layer—Pass: Yes, Neutral: No, Fail: Yes. (ii) Authorization Layer—Pass: Yes, Neutral: Yes, Fail: Yes. (iii) Alias Layer—Pass: Yes, Neutral: No, Fail: No. (iv) Authentication Layer—Pass: Yes, Neutral: Yes, Fail: Yes. (v) Alignment Layer—Pass: Yes, Neutral: Yes*, Fail: Yes * Not Applicable for the boxes found in “Domboxes”

(1) The Encryption Layer 421, checks whether the incoming message is encrypted or not. This layer uses TLS protocol. Encryption Layer Result Main state can be either PASS or FAIL. There is no sub state available for Encryption Layer. (2) The Authorization Layer 422, checks whether the mail sending server is authorized to carry the message or not for the “Envelope Domain”. This layer uses a standard called Sender Policy Framework (SPF). Authorization Layer Result Main state can be either PASS, NEUTRAL or FAIL. NEUTRAL state can have one of the following sub-states: NONE, NEUTRAL. FAIL state can have one of the following sub-states: FAIL, SOFTFAIL, TEMPERROR, PERMERROR. (3) The Alias Layer 423, checks whether the “Envelope Domain” and “Message Domain” are authorized alias for the “Dombox Domain”. This layer uses our proprietary standard called Sender Alias Domains (SAD). This layer contains two sub layers. Envelope Layer 424 and Message Layer 425. (3a) The Alias—Envelope Layer 424, checks whether the “Envelope Domain” is an authorized alias for “Dombox Domain”. The Alias-Envelope Layer Result main state can be one in the following. PASS or FAIL. PASS state can have one of the following sub-states: FAKEPASS, DIRECTPASS, INDIRECTPASS. (3b) The Alias—Message Layer 425, checks whether the “Message Domain” is an authorized alias for “Dombox Domain”. The Alias—Message Layer Result main state can be one in the following. PASS or FAIL. PASS state can have one of the following sub-states: FAKEPASS, DIRECTPASS, INDIRECTPASS. The overall Alias Layer 423 result depends on the sub layer results. If one sublayer result is fail, then the overall Alias Layer 423 result is Fail. Note: Alias Layer can have only “PASS” result. When the layer result is “FAIL”, mail will be rejected. Mail may be accepted only in development/testing mode when the result is FAIL. (4) The Authentication Layer 426, checks whether the mail is digitally signed by the sending server. This layer uses the standard DomainKeys Identified Mail (DKIM). Authentication Layer Result main state can be one in the following. PASS, NEUTRAL or FAIL. NEUTRAL state can have the following sub state: NONE. FAIL state can have one of the following sub-states: FAIL, TEMPERROR, PERMERROR. (5) The Alignment Layer 427, checks whether the “Message Domain” is aligned properly with SPF Domain and DKIM domain. If not aligned, then it applies the policy fetched from the “Message Domain”. This layer uses a standard called “Domain-based Message Authentication, Reporting and Conformance (DMARC)”. Alignment Layer Result main state can be one in the following. PASS, NEUTRAL or FAIL. There is no sub state available for Alignment Layer.

### 6. Box Types

FIG. 2B illustrates the box types. The group “Mailboxes” 201 is divided into two types. Primary (P) 211 and Mailbox (M) 212. The group “Domboxes” 202 divided into three types. Dombox (D) 213 and Hybrid (H) 214 and Combox (C) 215. A user account can have only one Primary (P) box. A user account can have unlimited Mailbox (M) boxes, Dombox (D) boxes, Hybrid (H) boxes and Combox (C) boxes.

Each box type is designed for a different purpose. (i) Primary (P)—To have a “Normal Mailbox” that works exactly like Gmail. (ii) Mailbox (M)—To use as a 3rd party Mail Client. e.g. @gmail.com & To use as a 3rd party mail server. e.g. @yourcompany.com (iii) Dombox (D)—To let consumers have control over the “Isolated Mailbox”. (iv) Hybrid (H)—To provide “One-Click” newsletter subscription service. (v) Combox (C)—To let businesses have control over the “Isolated Mailbox”

### 6.1. Must Pass Layers

FIG. 4B illustrates the mandatory pass layers for each box type. “mandatory pass” means the layer result must be “PASS” to accept mail.

### 6.2. Box Features

Boxes come with the following features.

Make Offline—When a box is offline, it can't accept any new mail.

Delete—When a box gets deleted, only the box mail address will be lost. The mails can be recovered if you recreate the box. And yes, a deleted box can't be able to accept any new mails.

Format—Bulk deletes all the mails found in a particular box. Applicable only for Domboxes. {Normal Mailboxes usually contain Conversational Mails which are very important. So Format option is not available in Normal Mailboxes}. To completely delete the box along with its mails, you must “format” the box first and then use the “delete” option.

Mute—Prevents annoying mail notifications. Mail will be accepted but you won't be notified when a box is “Muted”.

Subscribe—When a user is “Subscribed” to the box, the user is voluntarily asking the domain to send newsletters/promotional mails.

Unsubscribe—This option helps you with the unsubscription nightmare. When a user is “Unsubscribed” to the box, the user is asking the site, not to send any newsletters/promotional mails. When the box status is “Unsubscribed” and our system find any new mails with “List-Unsubscribe” header and/or “Unsubscribe” link at the mail footer, then we automatically try to unsubscribe on behalf of the user and then instantly move the mail to the “Trash” folder. If a domain sends Promotional emails without “Unsubscribe” link, then they are breaking the law.

Set Password—Applicable only to Domboxes. Since boxes found in the Domboxes group are isolated for a single domain, we can use the box as a password manager for that domain. For example, if the consumer create a Dombox for example.com, then we should allow the consumer to generate a random password for that domain. The password will be uniquely generated for that domain. So the consumer can give that password while signing up to that domain. This prevents the password reuse in all websites. The consumer can generate the password with the help of browser extensions.

Nuke—Applicable only to Domboxes. This option combines the Delete and Format option. I.e. Completely erases everything related to that particular Dombox.

### 6.4. Box Type: Primary (P)

The Box Type Primary (P) 211 refers to the email address user picked while registering to our mail system. A user can have only one email address as a Primary (P) box. Primary (P) box address should be used as username for logging in. Primary (P) box CANNOT be deleted by the user. Primary (P) box address should be used only for real conversations. (e.g. Sending mail to your family, friends, colleagues etc.). You can have only one box of this type. Whereas in other box types you can have unlimited boxes. This “only one box” is called “Primary” box. In our mail service, the “Primary” box is equivalent to your @gmail address. But you should use that only for real conversational mails. If you are not planning to use our “Domboxes” feature, then you are welcome to use your Primary box for all types of mails (like Gmail). This is the box type you get when you sign up for our mail service. You can get this box via signup form. Must Pass Layers: None. Note: Although there is no requirement for “Pass” in this box type, that doesn't mean mail will be accepted when all layers are failed. Primary email address will be used as username to log into the Dombox mail system. Domkey also can be used to log into the Dombox mail system since it's unique per account.

### 6.5. Box Type: Mailbox (M)

Mailbox (M) 212 boxes are additional “Normal Mailboxes”. This box type usually requires a nominal fee. For most users, there won't be a need for this box type. Only the “Primary” box is enough. A “box” found in Mailboxes group is called “Mailbox”. The term “Mailbox” always refers to any box found in “Mailboxes” group. Since Primary (P) is also a box type found under mailboxes group, we can call it a Mailbox. Since the term “Mailbox” already refers to any box found in the Mailboxes Group, we use the letter M in parentheses to indicate “Mailbox Box Type”. In other words, “Mailbox” refers to ANY Box found in “Mailboxes” Group. But “Mailbox (M)” refers to the Box Type found in “Mailboxes” Group. This box type can behave in two ways. (1) As a Mail Server (2) As a Mail Client. To get this box, Activate our “Mailboxes” extension and then use the “Add Mailbox” link found in the sidebar menu. Must Pass Layers: None.

### 6.6. Box Type: Dombox (D)

Since the term “Dombox” already refers to any “box” found in the Domboxes Group, we use the letter D in parentheses to indicate “Dombox Box Type”. In other words, “Dombox” refers to any box in “Domboxes” Group. But “Dombox (D)” 213 refers to the Box Type found in “Domboxes” Group. “Dombox (D)” boxes CAN be deleted by the user at any time.

### 6.7. Box Type: Hybrid (H)

The term “Hybrid” refers to a Dombox that must pass 5 layer checks for all incoming mails. The five layers are Encryption Layer 421, Authorization Layer 422, Alias Layer 423, Authentication Layer 426 and Alignment Layer 427. These layer checks already explained in the previous sections. “Hybrid (H)” 214 boxes CAN be deleted by the user at any time.

### 6.8. Box Type: Combox (C)

The term “Combox” refers to a Dombox that is under contract. In other words Combox refers to a “Contract-based Dombox”. Combox (C) 215 boxes CANNOT be deleted by the user. When the contract expires, the box will be converted into a “Hybrid (H)” 214 box. Combox (C) box type also must pass 5 layer checks for all incoming mails just like Hybrid (H) box type. Both Hybrid (H) and Combox (C) functions similarly except that Hybrid (H) boxes CAN be deleted anytime or put offline by the user. A user can upgrade to Hybrid (H) box from Dombox (D) manually. A user can also downgrade to Dombox (D) from Hybrid (H) box manually. However the downgrade from Combox (C) to Hybrid (H) box does not require any user intervention. It's automatic. When a Combox contract expires, the box will be automatically downgraded to Hybrid. Hybrid (H) boxes are very useful when “Telescribing”. “Telescribe” is our one-click newsletter subscription service.

Note: Some layers are complicated to configure for non tech-savvy users. So the requirements can be relaxed. For example, the system can work only with Authorization Layer (SPF) and Alias Layer (SAD) or even with Alias Layer alone when combined with Receiver Policy Framework (RPF). There is no need to mandate the other layers. However, it is highly recommended to configure other layers, so the incoming mails can get full 5 marks for Mail Score and looks trustworthy in front of reader's eyes.

### 7. Dombox

We cannot expect every website in the world to support all our 5 layers. So for Dombox (D) box type, only the “Alias Layer” must be passed. If all other four layers fail, then most likely we will reject the mail. But if most of them are “Neutral”, then we may accept the mail. Let's say we accept mail even when “Alias Layer” result is “Fail”. This means we are accepting mails from every domain on the Internet. The “Alias Layer” is what makes the Dombox special. Without it, “Dombox” will be equivalent to the “Mailbox” since it's accepting mail from anyone. Since we are allowing unlimited “Domboxes”, without “Alias Layer”, the users can run their own version of mail service inside their account. So for Dombox (D) box type “Alias Layer” must be passed for accepting the mail.

Dombox (D) box type has the options “Delete” and “Make Offline”. If somehow a spammer sends you spam mails to the Dombox (D), that means that domain is vulnerable to “email spoofing”. So you have the following options. (1) Contact the website owner and demand them to configure “email spoofing” prevention mechanisms like SPF, DKIM and DMARC. (2) Delete the box and move on (This is why we gave you those privileges right?)

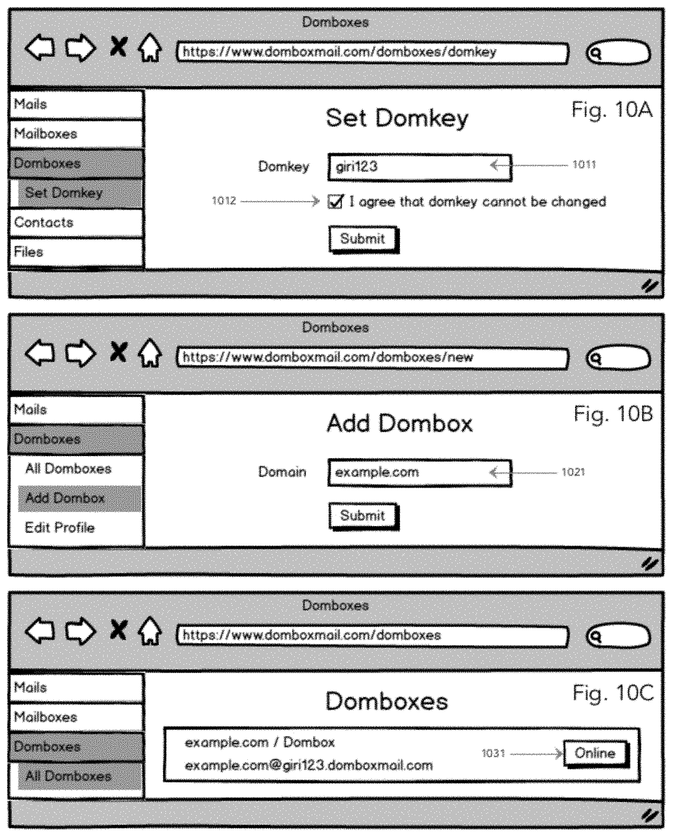

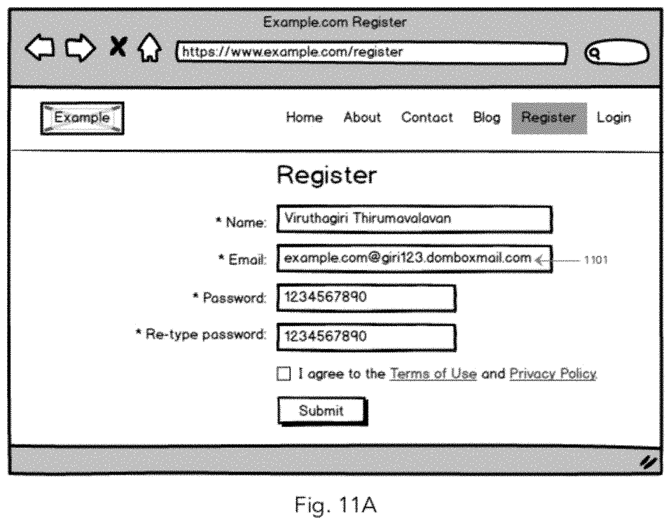

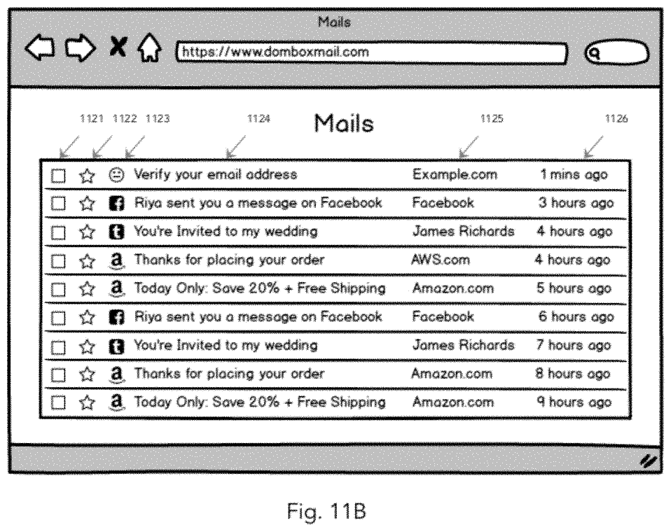

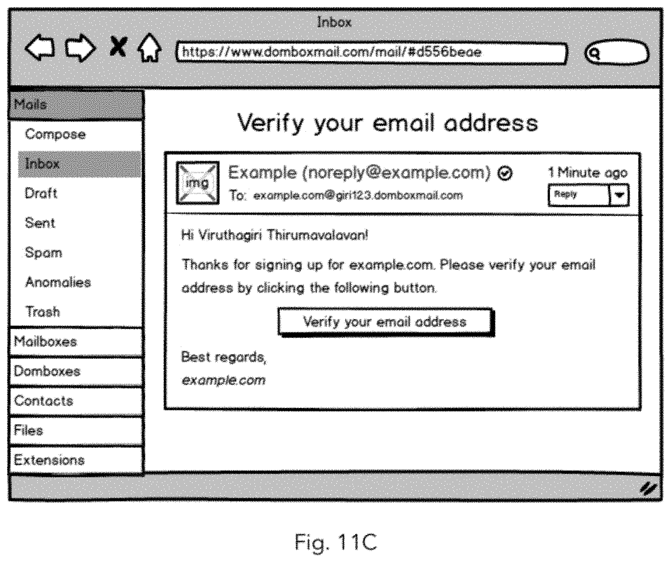

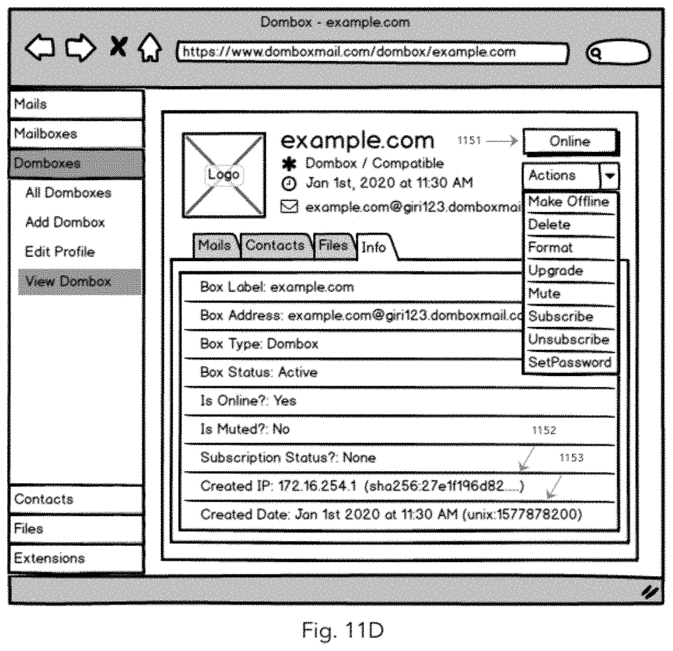

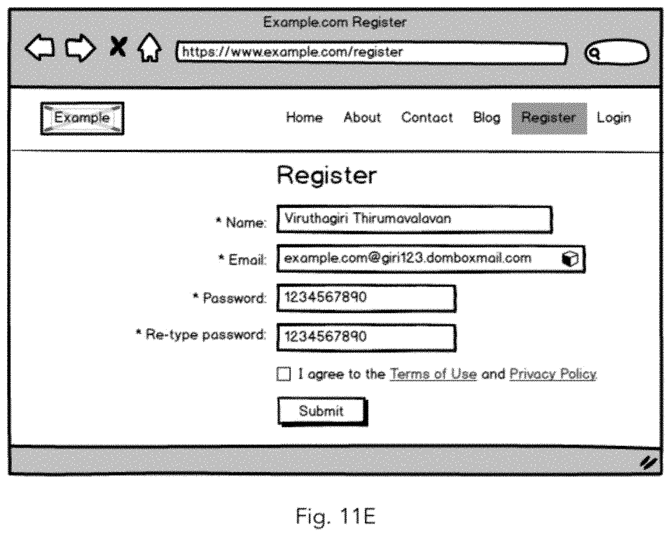

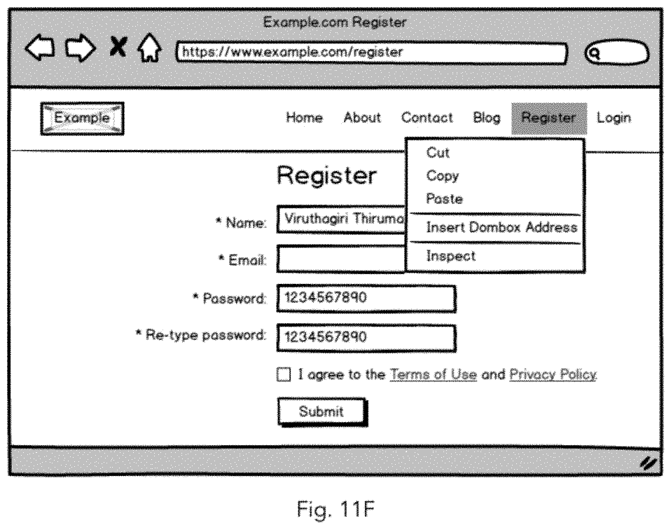

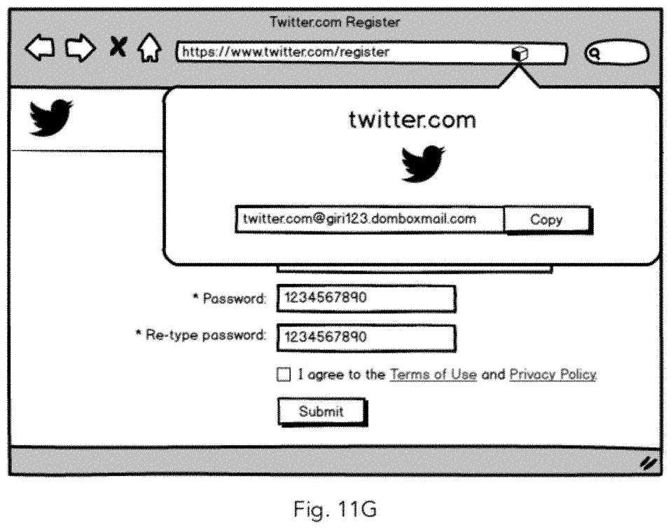

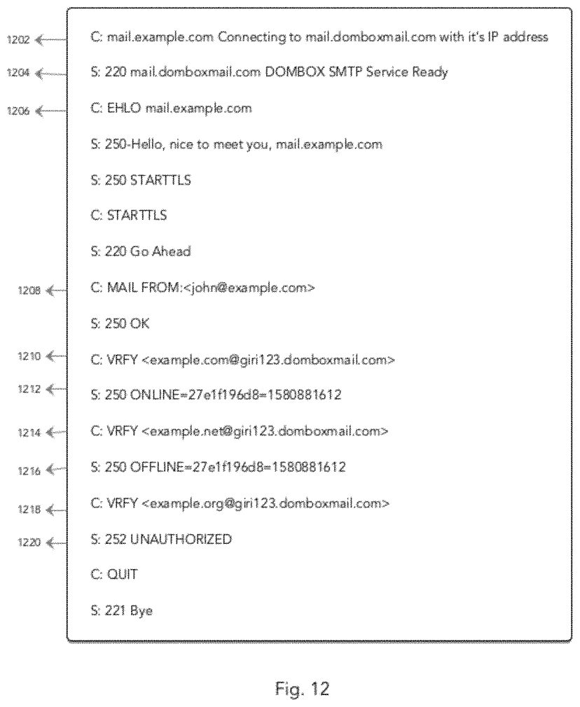

FIG. 10A illustrates the “set domkey” page layout. The term “Domkey” is already explained in prior section. You must set the “Domkey”, before accessing the “Add Dombox” page. If the Domkey already not set, then the user will be redirected to the “Set Domkey” page. In FIG. 10A user sets the Domkey 1011. Domkey once set cannot be changed. So users agree to that by checking the checkbox 1012. Domkey is a global identifier for all Domboxes and should be set only once. If Domkey has already been set, user can proceed to Dombox creation.

FIG. 10B illustrates the “Add Dombox” page layout. A Dombox requires a valid domain name or a url to generate the address. In FIG. 10B user enters example.com 1021 as domain.

Users need to enter a valid domain or valid url in order to create a Dombox. e.g. http://example.com, example.com or http://example.com/hello-world. User entered domain or URL should be cleaned up and converted into a valid domain. e.g. example.com. Dombox domain should be a main domain. So xyz.example.com will be converted to example.com. Once we convert the domain into a valid domain, we pull the SAD record from the cleaned up domain. If there is a SAD record found and the SAD record contains a valid domain for “box” config, then we switch the domain to value found in the “box” config and then proceed. Else we proceed with the domain user provided. We query our database to check whether the Dombox already exists for that domain or not for that particular user. If it already exists, then we redirect the user to that particular Dombox. So the user can check their emails. The url structure of Dombox looks like this. https://www.domboxmail.com/dombox/example.com. Users will be redirected to such url, if Dombox already exists. If Dombox does not already exist, then we generate a new dombox for that domain. So if the user entered the domain example.com, then the dombox address will be example.com@giri123.domboxmail.com.

example.com@giri123.domboxmail.com is a dedicated mail address for example.com. By default only mails from example.com are allowed in that dombox. However example.com domain admin can add SAD record in example.com to allow emails from other domains. SAD already explained in earlier sections. Once the dombox is generated, we redirect the user to that dombox. If example.com is the newly created dombox, then the user will be redirected to https://www.domboxmail.com/dombox/example.com

A Dombox creation can originate from multiple sources. A browser extension that's created for filling signup/login forms, can provide a valid domain input and then get the generated email address as a response. Browser extension can also include a “Set Password” request and then get the generated password as response.

FIG. 100 illustrates the “All Domboxes” page layout. Domboxes page lists the boxes found in the Domboxes 202 group. i.e. This page contains all the boxes that have the following box types. Dombox (D) 213, Hybrid (H) 214 and Combox (C) 215. Since the example.com dombox is already created via “Add Dombox” page 1021, FIG. 100 shows the dombox example.com@giri123.domboxmail.com. example.com dombox has “Online” 1031 status. That means the box is active and accepting mails from others.

### 8. Combox (C)

The Combox (C) box type revokes the box deletion and box offline privileges from the consumer. The term “Combox” refers to a Dombox that is under contract. In other words, Combox refers to a “Contract-based Dombox”. The term “Contract” refers to an agreement between “Consumer” and the “Business”. To initiate a Contract, business owners must register an App on our website and then they have to display a button on their websites/apps. To register an App, businesses need to verify their domain first, since all contracts are linked to a particular domain. When a contract is signed, it also creates the Combox (C) for that contract automatically. Combox (C) cannot be created from our website. A user needs to visit a third party website and then click our “Auth” button to initiate the “Contract”. The whole point of Combox (C) is that the box can accept only the emails that pass all 5 layers. i.e. Score 5 mails. The business agrees to that part and we revoke the box deletion and box offline privileges from the consumer. Business Side: Stable Users. Consumer Side: Spam free Combox (C)

Combox (C) deals with OAuth apps like “Sign in with Google”. Our button is called “Teleport”. Dombox (D) and Hybrid (H) boxes can also be created via the “Teleport” button.

### 9. Telescribe

Telescribe is our one-click newsletter subscription service. It's like the “Facebook Like” button you see on websites, but for newsletter subscriptions. When the “Telescribe” button is clicked a “Hybrid (H)” box will be created for the domain found in the request. A website owner can configure webhook endpoints. The subscriber data will be pushed during subscribe/unsubscribe events.

### 9.1. Box Type—Hybrid (H)

Hybrid (H) box is the same as Combox (C) except it can be put offline and deleted. Or you could say Hybrid (H) box is the same as Dombox (D) except it needs to pass all 5 layers. Hybrid (H) box offers both Dombox (D) features as well as Combox (C) features. So it's the love child of Dombox (D) and Combox (C). Hybrid (H) box type can be helpful in three situations. (1) Telescribe—Our “One-Click” newsletter subscription service (2) Upgrade—Consumers can voluntarily upgrade from “Dombox” to “Hybrid” if they are absolutely sure that the website “Pass” all 5 layers (3) Downgrade—When a contract gets terminated, the box will be downgraded from “Combox” to “Hybrid”.

### 9.2. Dombox vs Hybrid vs Combox

Dombox (D)=>Make Offline?: Yes, Delete?: Yes, All 5 layers must be passed?: No
Combox (C)=>Make Offline?: No, Delete?: No, All 5 layers must be passed?: Yes
Hybrid (H)=>Make Offline?: Yes, Delete?: Yes, All 5 layers must be passed?: Yes

### 10. Real-Time Email Address Verification

FIG. 11A illustrates a “third party registration page” where Dombox email address can be used. If the user created a Dombox for example.com, then he/she should visit the example.com register page and use the dombox address for email address 1101 while signing up. A browser extension can generate/fill the email field 1101 and password field with one click. Upon submitting the form usually websites send a confirmation email to verify the email address.

FIG. 11E illustrates icon-click “dombox address generation” via browser extension. When the icon is clicked, the extension captures the “current domain” and then sends a “dombox address generation” request to the server. The server generates and returns the address. The extension fills the form field with the returned value. Note: If the dombox address already exists for the requested domain, the address will not be created. But the value will be returned.

FIG. 11F illustrates right-click “dombox address generation” via browser extension. The method is similar to the icon-click method. But here, the user needs to right click and then click the “insert dombox address” option. So two clicks here.

FIG. 11G illustrates pop-up “dombox address generation” via browser extension. In this method, the user clicks the extension icon. The address is returned in the popup. User “copy” the address and “paste” that in the form.

FIG. 11B illustrates what the mails page looks like. Users can take bulk actions like Delete, Mark as read etc using the checkbox 1121 option. Mails can be starred 1122 or unstarred. The icons 1123 represents the “Dombox Domain” logo. When the icon clicked, you will be redirected to the individual dombox page (Refer FIG. 11D) where you can browse that individual dombox mails. The email subject 1124, sender name 1125 and the date 1126 are also shown in FIG. 11B. The sender names AWS.com and Amazon.com has the same icon for “Dombox Domain”. That's because the Dombox is created for Amazon.com, AWS.com delivered the mail to the amazon.com dombox with the help of SAD record.

FIG. 11C illustrates the email address verification email sent by example.com. This email requires end user intervention to confirm the email address. We can make this process easier. Example.com can confirm the end user email without sending that real email message. The following section explains how that works.

### 10.1 VRFY Command

VRFY is one of the SMTP commands introduced in RFC 821. VRFY command asks the server to verify an email address. Most mail servers do not support VRFY command in order to prevent abuse. For example, spammers can use the VRFY command and scrap valid email addresses and send spam mails later.

RFC 5321 mandates VRFY command. Instead of disabling it completely, the server should return the 252 code like this.

VRFY <john@example.com>

252 Cannot VRFY user, but will accept message and attempt delivery

Our Dombox servers honours VRFY command when the following conditions are met.

(1) The VRFY address is a valid “Isolated Mailbox” address. I.e. It's a dombox address which looks like example.com@test123.domboxmail.com or test123$example.com@domboxmail.com

(2) Authorization Layer Passed for at least one of “Envelope Domain”, HELO/EHLO Domain or Dombox Domain. [We fetch the SPF record from one of the said domains and check whether Client IP 102 address whitelisted in that SPF record]

(3) Alias Layer Passed for the “Dombox Domain”. E.g. A user created a Dombox for quora.com. Quora.com can verify whether the Dombox exists or not without sending a verification email to the user.

When the email address is a mailbox address we respond with 252 code. I.e. VRFY command would work for example.com@test123.domboxmail.com, but we always return 252 code for mailbox addresses that looks like john@example.com

10.2. Sample Verification Request

FIG. 12 illustrates a sample real-time verification request.

mail.example.com is connecting to mail.domboxmail.com with its IP address 1202. The “Client IP” (Mail Sending Server IP/Connection IP) address is extracted from here.

The Server responds with 220 code 1204 if the server is ready. This 220 response is known as SMTP banner. The client should look for the text “DOMBOX” in the SMTP banner 1204. If the text is not present, that means the server is NOT a Dombox-based Mail Server. So the client can send a regular “Confirm your email address” mail instead [Refer FIG. 11C].

In the future, anyone can have the Dombox Mail Server on their servers as MTA. So the domain does not always end with “domboxmail.com”. The SMTP banner check is the second layer of check. The first layer of check is performed by the Client when the user submit their email address. Address structures like “twitter.com@test123.example.com” or “test123$twitter.com@example.com” says that the submitted address is a Dombox-based email address. The client confirms that by checking the text “DOMBOX” in the SMTP banner.

Our server respects verify requests only when the connection is secure. So EHLO 1206 command and STARTTLS is mandatory. This is because we are gonna transmit data 1212 like Box Status, Dombox Creation IP address and Dombox Creation Date to the sender. The data can be modified by a middleman if the connection is not secure.

It is the client's responsibility to validate the server's SSL/TLS certificate. For example, if the client would like to verify example.com@giri123.domboxmail.com, it needs to establish a secure connection by issuing STARTTLS command. The client must check whether the server certificate is valid for “domboxmail.com” or “*.domboxmail.com” or “giri123.domboxmail.com”. If the certificate is not valid, then the client should send the normal verification email [Refer FIG. 11C]. Please note that, mails can be hosted in third party mail servers too. So the MX record can point to other servers like Google.com. In such cases, the server and client can utilise solutions like DANE with DNSSEC.

When VRFY command is issued, we make sure whether the Client IP is allowed for the issued VRFY address 1210. We follow the exact RCPT TO validation approach as described in FIG. 9A in VRFY command too. I.e. MAIL FROM SPF records, Dombox Domain SAD record, if no SAD record found fallback to SPF record.

Our server responds with box status 1151, “dombox address creation IP address” 1152 and the “dombox address creation time” in unix timestamp format 1153.

VRFY <example.com@giri123.domboxmail.com>

250 ONLINE=27e1f196d8=1580881612

The “=” symbol in the 250 response is a string separator.

### 10.2.1. Box Status

The box status 1151 is included in the VRFY response 1212. This part is not necessary, but included for informational purposes.

### 10.2.2. Created IP

The VRFY response 1212 contains the “IP address” 1152 that created the dombox. For privacy reasons, the “IP address” is returned as “Hash”. E.g. sha256 Hash.

The Client should compare the “sha256 Hash of the signup form submitted IP” with “sha256 hash of the dombox address creation IP”. If it doesn't match, then verification is failed. So send normal verification mail [Refer FIG. 11C].

### 10.2.3. Created Time

The VRFY response 1212 contains the “Creation Time” 1153 of the dombox. This is in unix timestamp format. E.g. sha256 Hash.

The client should Compare the “dombox address creation unix timestamp” 1153 with the current timestamp (i.e. the signup form submitted time). If the difference is not more than 30 minutes, then most likely it was created by the person who submitted the signup form.

Note: Since we are dealing with Real-Time Verification here, our server responds with the default “252 Cannot VRFY user but will accept message and attempt delivery” when the “dombox address creation time” is not less than 24 hours. We are doing that for privacy reasons.

example.net@giri123.domboxmail.com VRFY command 1214 is a success because it passed via SAD.

### 10.2.4. PIN

Since the verifier primarily relies on IP address to verify the address, a friend or colleague of the end user who has the same public IP address, can be able to hijack the account. So if necessary, we can ask the end user to set a four digit PIN for Real-Time address verification. During signup, the website or app, ask the PIN and include that in the verification request.

VRFY <1234$example.com@giri123.domboxmail.com>

250 ONLINE=27e1f196d8=1580881612

Where 1234 is the pin code passed by the end user to the service.

### 10.2.5. Normal Verification Mail.

FIG. 11C illustrates the normal verification mail. A separate mail session is not required. After the 252 response 1220, the client can continue the normal verification mail by issuing the RCPT TO 108 command.

10.3. VRFY without HELO/EHLO

VRFY request is possible without issuing HELO/EHLO.

mail.quora.com Connecting to mail.domboxmail.com with its IP address

220 mail.domboxmail.com Dombox SMTP Service Ready

VRFY <quora.com@test123.domboxmail.com>

250 ONLINE=27e1f196d8=1580881612

QUIT

221 Bye

In the above example, the VRFY command is issued without issuing HELO/EHLO or MAIL FROM command. SAD record is not necessary here. We need to fetch the SAD record only when there is a MAIL FROM domain or HELO/EHLO domain. So, We fetch the SPF record of Dombox Domain (quora.com in this case), and then check whether the Client IP is whitelisted in the SPF record. If yes, the verification request is honoured.

10.4. VRFY without STARTTLS

VRFY without encryption must be discouraged for privacy reasons since we deal with user IP addresses here.

### 10.5. RCPT TO Instead of VRFY

Our VRFY feature can also be achieved via RCPT TO command.

RCPT TO:<example.com@giri123.domboxmail.com>

250 ONLINE=27e1f196d8=1580881612

What is claimed is:

1. A method for verifying email address, the method comprising:
receiving a verification request at a server for an email address of a user from a service;
checking whether the service is authorized to perform the verification request for said email address by performing one or more checks;
responding to the verification request with a result when the service is authorized; and
wherein the email address is associated with a primary domain of the service.

2. The method of claim 1, wherein the verification request is received when the user creating an account on said service.

3. The method of claim 1, wherein said one or more checks comprises:
comparing at least part of a domain with a plurality of domains authorized by the service.

4. The method of claim 3, wherein the plurality of domains are authorized in an external server.

5. The method of claim 1, wherein said one or more checks comprises:
comparing a client IP address with a list of IP addresses authorized by the service.

6. The method of claim 1, wherein the server requires a secure connection.

7. The method of claim 1, wherein the result comprises a creation IP address of said email address.

8. The method of claim 7, wherein the creation IP address is in hash format.

9. The method of claim 1, wherein the result comprises a creation time of said email address.

10. The method of claim 9, wherein the creation time is in unix timestamp format.

11. The method of claim 1, wherein the verification request comprises a PIN number provided by the user.
